(19) United States
(12) Patent Application Publication
(10) Pub. No.: US 2020/0272852 A1
(43) Pub. Date: Aug. 27, 2020

(54) CLUSTERING

(71) Applicant: HEWLETT PACKARD ENTERPRISE DEVELOPMENT LP, Houston, TX (US)

(72) Inventors: Kave ESHGHI, Los Altos, CA (US); Mehran KAFAI, Redwood City, CA (US)

(21) Appl. No.: 16/063,593

(22) PCT Filed: Dec. 18, 2015
(86) PCT No.: PCT/US2015/066830

§ 371 Date: Jun. 18, 2018

(51) Int. Cl. G06K 9/62; G06N 5/02

(52) U.S. Cl. CPC G06K 9/6218; G06K 9/623; G06N 5/025; G06K 9/6232; G06K 9/6215

(57) ABSTRACT

An example method is provided in according with one implementation of the present disclosure. The method comprises computing, via a processor, a ranked elements list for each of a plurality of objects. The method also comprises iteratively computing, via the processor, a blacklist of elements for the objects. The method further comprises determining, via the processor, duster centers that include top ranked non-blacklisted elements, and assigning, via the processor, each object to at least one duster center.

A variety of analytic tasks may be performed on data (e.g., big data that generally exceeds the processing capacity of conventional systems), and the results may be provided to a user. The analytics tasks may include creating and running queries, indexing, retrieval, clustering, pattern detection, classification, and others. Clustering or partitioning of data is typically the task of grouping a set of items or objects in such a way that objects in the same group (e.g., duster) are more similar to each other than to those in other groups (e.g. dusters).

### BRIEF DESCRIPTION OF THE DRAWINGS

FIG. 1 is a schematic illustration of an example system for clustering data objects by computing a blacklist in accordance with an implementation of the present disclosure.

FIG. 2 illustrates a flowchart showing an example of a method for clustering data objects by computing a blacklist ire accordance with an implementation of the present disclosure.

FIG. 3 illustrates a flowchart showing an example of a method for computing a ranked elements list for data objects in accordance with an implementation of the present disclosure.

FIG. 4 illustrates a flowchart showing an example of a method for computing a blacklist for the objects in accordance with an implementation of the present disclosure.

FIG. 5 is a example block diagram illustrating a computer-readable medium in accordance with an implementation of the present disclosure.

### DETAILED DESCRIPTION OF SPECIFIC EXAMPLES

Many entities (e.g., enterprises, organizations) utilize databases for storage of data relating to the entities. For example, a business may maintain a database of customer information, and the customer information may be accessed by querying the database. Further, entities may generally store vast amounts of data originating from their business, including operations data, customer feedback data, financial data, Human Resource data, and so forth. Data stored in these databases may be accessed and updated for various purposes.

As described above, data stored in a database may be accessed and analyzed in real-time for various purposes. For example, clustering or partitioning of data has become increasingly popular in recent years. Many organizations use various data clustering methods and techniques to help them analyze and cluster different types of data (e.g., customer surveys, customer support logs, engineer repair notes, system logs, etc.). As used herein, the terms “group” and “cluster” are to be used interchangeably and refer to a set of items that are grouped in a way such that items in the same group are more similar to each other than to those in other groups. As used herein, the terms “data object” and “object” are to he used interchangeably and refer to a data element (e.g., vector of numbers) that, for example, may be stored in a database.

In many situations, exiting clustering techniques may be slow, inaccurate, and inefficient. Therefore, there is always a need for an improved clustering techniques that provide faster and more accurate analysis of different data.

In this regard, according to examples, techniques for clustering data objects by computing a blacklist of elements for the data objects are disclosed herein. In the proposed techniques, a blacklist of elements may be used to improve clustering of different data. When data objects are similar, they tend to have common elements (e.g., when an object is represented as a vector). Therefore, the techniques described herein propose using the elements of the different data object to determine similarity between the objects and to cluster the objects accordingly. The techniques described herein propose computing a ranked list for each data object, iteratively determining a blacklist of elements (i.e., elements that cannot be cluster centers for the objects), and assigning each of the objects to cluster centers (i.e., cluster identifiers that form the individual clusters) that include top ranked non-blacklisted elements for the objects. The proposed techniques enhance the efficiency and the accuracy of clustering.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. Furthermore, the term “based on,” as used herein, means “based at least in part on.” It should also be noted that a plurality of hardware and software based devices, as well as a plurality of different structural components may be used to implement the disclosed methods and devices.

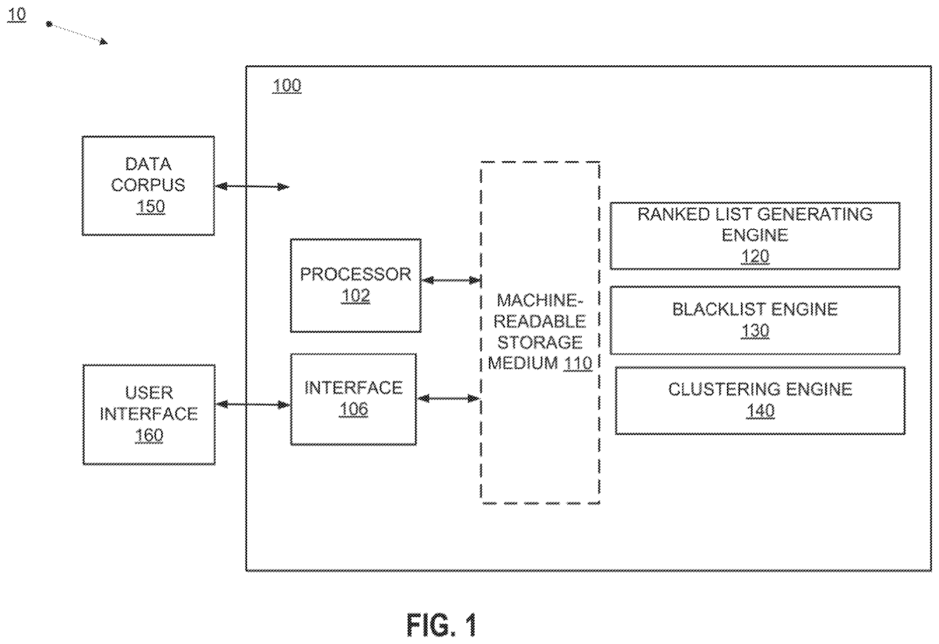

Referring now to the figures, FIG. 1 is a schematic illustration of an example system 10 for clustering data objects by computing a blacklist. The illustrated system 10 is capable of carrying out the techniques described below. As shown in FIG. 1, the system 10 is depicted as including at least one computing device 100 (e.g., application server, compute node, desktop or laptop computer, smart phone, etc.). In the embodiment of FIG. 1, computing device 100 includes a processor 102, an interface 106, and a machine-readable storage medium 110. Although only computing device 100 is described in details below, the techniques described herein may be performed by several computing devices or by engines distributed on different devices, Thus, the computing device 100 may or may not be an independent computing device. The computing device 100 may include additional components and some of the components depicted therein may be removed and/or modified without departing from a scope of the system that allows for carrying out the functionality described herein.

In one example, the computing device 100 (or another computing device) may communicate with a data corpus 150 and with an interactive user interface 160 (e.g., graphical user interface). The data corpus 150 may include different types of data objects. The data in the data corpus 150 may include text-like data, categorical data, numerical data, structured data, unstructured data, or any other type of data. The device 100 may receive an incoming data stream of data objects from the data corpus 150.

The computing device 100 may implement engines 120-140 (and components thereof) in various ways, for example as hardware and programming. Each of the engines 120-140 may include, for example, a hardware device including electronic circuitry for implementing the functionality described below, such as control logic and/or memory. In addition or as an alternative, the engines 120-140 may be implemented as any combination of hardware and software to implement the functionalities of the engines, The programming for the engines 120-140 may take the form of processor-executable instructions stored on a non-transitory machine-readable storage medium and the hardware for the engines 120-140 may include a processing resource to execute those instructions. A processing resource may include a number of processors and may be implemented through a single processor or multi-processor architecture. In an alternative example, engines 120-140 may be distributed between the computing device 100 and other computing devices. It is to be understood that the operations described as being performed by the engines 120-140 of the computing device 100 that are related to this description may, in some implementations, be performed by external engines (not shown) or distributed between the engines of the computing device 100 and other electronic/computing devices.

Processor 102 may be central processing unit(s) (CPUs), microprocessor(s), and/or other hardware device(s) suitable for retrieval and execution of instructions (not shown) stored in machine-readable storage medium 110. Processor 102 may fetch, decode, and execute instructions to identify different groups in a dataset. As an alternative or in addition to retrieving and executing instructions, processor 102 may include electronic circuits comprising a number of electronic components for performing the functionality of instructions.

Interface 106 may include a number of electronic components for communicating with various devices. For example, interface 106 may be an Ethernet interface, a Universal Serial Bus (USB) interface, an IEEE 1394 (Firewire) interface, an external Serial Advanced Technology Attachment (eSATA) interface, or any other physical connection interface suitable for communication with the computing device. Alternatively, interface 106 may be a wireless interface, such as a wireless local area network (WLAN) interface or to near-field communication (NFC) interface that is used to connect with other devices/systems and/or to a network. The user interface 160 and the computing device 100 may be connected via a network. In one example, the network may be a mesh sensor network (not shown), The network may include any suitable type or configuration of network to allow for communication between the computing device 100, the user interface 160, and any other devices/systems (e, g., other computing devices, displays), for example, to send and receive data to and from a corresponding interface of another device.

In one example, the ranked list generating engine 120 may compute a ranked elements list for each of a plurality of objects (e.g., received from the data corpus 150). As explained in additional details below, the ranked list may include an index of elements of each data object (e.g., index of elements that refer to the position of a vector of the object) and may be computed by using an orthogonal transform. As noted above, the data corpus may include various data objects. Various techniques may be used to compute the ranked elements list for each object. In one implementation, the ranked list generating engine 120 may: compute a replicated vector for each object from an input vector associated with the object; apply a random permutation to the replicated vector for each object; perform orthogonal transform to the replicated vector for each object to generate an index vector; and generate a ranked elements list for each object from the index vector.

The blacklist engine 130 may iteratively compute a blacklist of elements for the objects. In one example, the blacklist engine 130 may iteratively: select a top ranked element from the ranked list of elements, iteratively determine, for the top ranked element, the count of objects that have the same top ranked element. The blacklist engine 130 may further identify the top ranked element with a highest count of objects, and place the element with the highest count of objects on the blacklist of elements. That way, the blacklist engine 130 may calculate the blacklist of elements.

The blacklist engine 130 may further iteratively update the blacklist of elements by including another element having the highest count of objects from the top ranked elements for the plurality of objects, where the ranked list of elements excludes elements that are already on the blacklist of elements. The blacklist engine 130 may identify a plurality of elements having the highest count of objects from the elements for the plurality of objects, and may place the plurality of element having the highest count of objects on the blacklist of elements. That way, multiple element may be simultaneously added to the blacklist.

The clustering engine 140 may determine cluster centers that include top ranked non-blacklisted elements. In other words, the engine 130 may identify different elements that can be used to duster the plurality of objects since these elements are common for many objects. The clustering engine 140 may then assign each object from to at least one cluster center. That way, the clustering engine 140 may cluster the object by grouping objects with similar elements together.

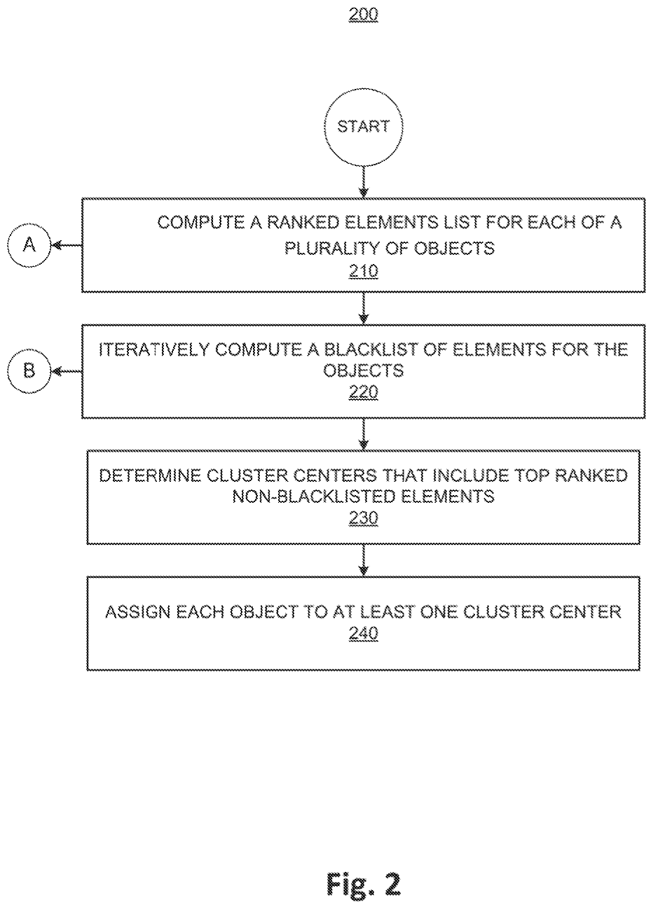

FIG. 2 illustrates a flowchart showing an example of a method 200 for clustering data objects by computing a blacklist. Although execution of the method 200 is described below with reference to the system 10, the components for executing the method 200 may be spread among multiple devices/systems. The method 200 may be implemented in the form of executable instructions stored on a machine-readable storage medium, and/or in the form of electronic circuitry.

In one example, the method 200 can be executed by at least one processor (e.g., processor 102 of device 100). In other examples, the method may be executed by another processor in communication with the system 10. Various elements or blocks described herein with respect to the method 200 are capable of being executed simultaneously, in parallel, or in an order that differs from the illustrated serial manner of execution. The method 200 is also capable of being executed using additional or fewer elements than are shown in the illustrated examples.

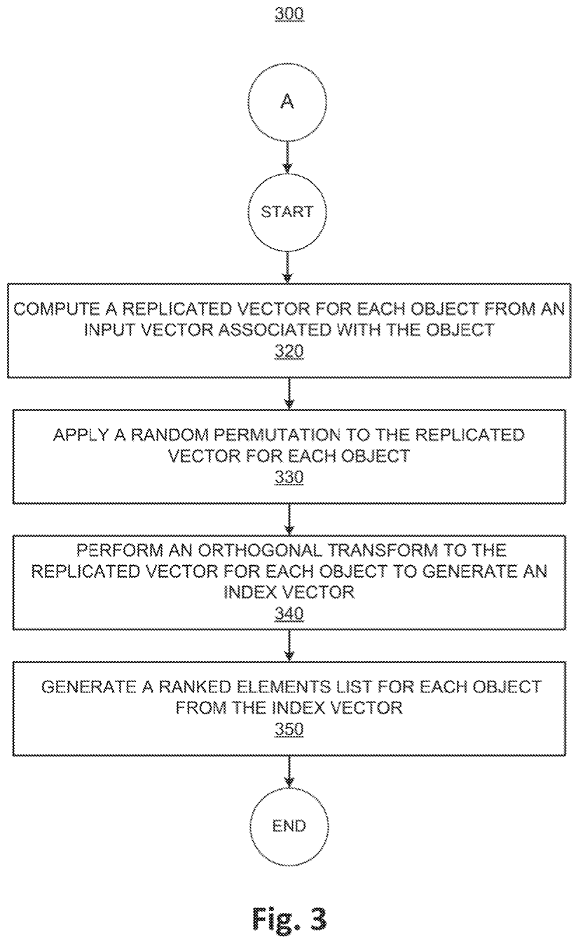

The method 200 begins at 210, where a processor may compute a ranked elements list for each of a plurality of objects. In one example, the ranked elements list includes an index of elements of each data object (e.g., index of elements that refer to the position of a vector of the object). Various techniques may be used to compute the ranked list for each object. An example technique is described below in relation to FIG. 3.

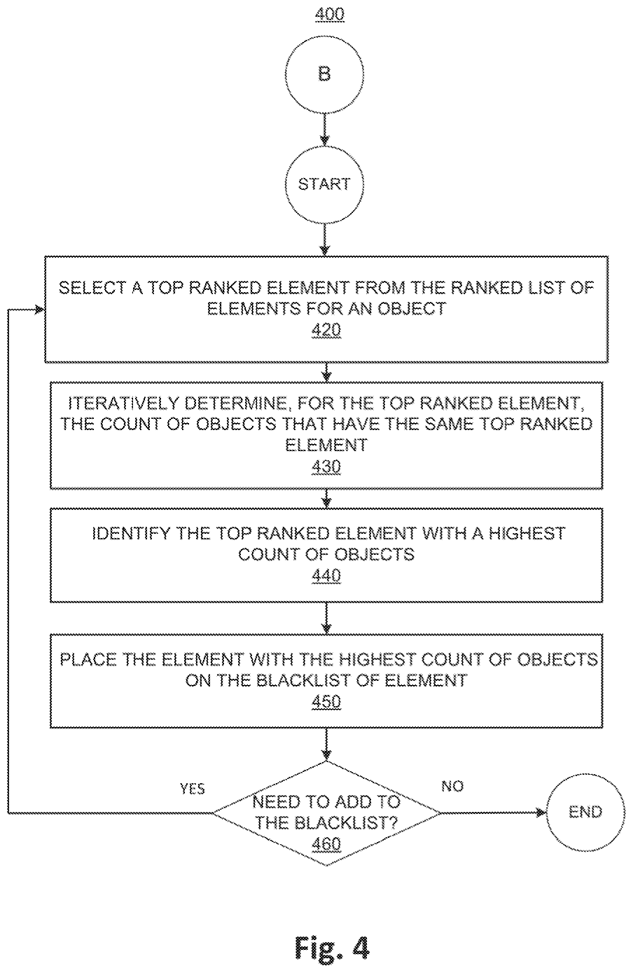

At 220, the processor may iteratively compute a blacklist of elements for the objects. An example technique for computing the blacklist of elements is described below in relation to FIG. 4. In one example, the processor may evaluate the ranked list of elements (i.e., the list may sorted based on the value of the elements). In other words, the processor may analyze a prioritized list of the elements for all objects. For the top ranked element (i.e., the element with the highest value on the list), the processor may determine the count of objects that have the same top ranked element. In other words, the processor may count how many objects are associated with the same top ranked element. The element with the highest count is usually not a very good element because the cluster that corresponds to that element will be a very big cluster and this dilutes the difference between the objects. The processor may then place the element with the highest count on the blacklist.

At 230, the processor may determine cluster centers that include top ranked non-blacklisted elements. In other words, the processor may identify top ranked elements not included in the blacklist of elements for the object and label them as cluster identifiers (i.e., cluster centers) that will help to form the individual clusters of objects. Each object may then be assigned to each of these cluster centers, one example, the processor may select each top ranked, non-blacklisted element for each object as a potential cluster center.

Next, the processor may assign each object to at least one cluster center (at 240). In one example, each object may be assigned to its top non-blacklisted element that was identified as a cluster center, Similar object would share the same elements (i.e., cluster centers) and, therefore, will be assigned to the same cluster centers to form a cluster of objects. The generated clusters are very well representative of the received similar data objects. The dusters take into account not only the similarity between the objects but also their differences. Therefore, mathematically, the generated clusters are more useful for future computational and analytical purposes.

FIG. 3 illustrate a flowchart showing an example of a method 300 for computing a ranked elements list for each of the plurality of data objects. Although execution of the method 300 is described below with reference to the system 10, the components for executing the method 300 may be spread among multiple devices/systems. The method 300 may be implemented in the form of executable instructions stored on a machine-readable storage medium, and/or in the form of electronic circuitry. In one example, the method 300 can be executed by at least one processor of a computing device (e.g., processor 102 of device 100).

The method 300 begins at 320, where a processor may compute a replicated vector R for each object from an input vector associated with the object. In some example, each data object may be represented as an input vector (e.g., a feature vector from the object). In other words, an object may be represented as an n-dimensional real value numerical input vector. Various techniques could be used to compute a replicated vector R from the input vector.

At 330, the processor may apply a random permutation to the replicated vector R for each object. Next, the processor may perform an orthogonal transform to the replicated vector R for each object to generate an index vector IX (at 340). In one example, the transform may be discrete cosine transform (“DCT”). As described below, various techniques may be used to generate the index vector IX.

In one example, the orthogonal transform to the replicated vector R may generate a transformed vector R′. The processor may sort the elements of the transformed vector R′ (e.g., in descending order) to generate the index vector IX. If, for example, the largest element of the transformed vector R′ is in position/coordinate 5, the index vector IX may have 5 as its first element. If, for example, the second largest element of the transformed vector R′ is in position 17, the index vector IX may have 17 as its second element, etc. In other words, the index vector may record the positions of the vector R′ when the positions are transformed. In another example, the processor may not use sorting but may generate the index vector by selecting the first N elements of the transformed vector R′, where N may be predetermined or flexible number.

At 350, the processor may generate a ranked elements list for each object from the index vector DC. The ranked list includes an index of the elements of the index vector IX, which refer to the positions of the transformed vector R′. In other words, the ranked element includes an index of elements of each data object. Thus, based on the index vector IX, the processor may generate the ranked list for each object in one implementation, the ranked list may be the index vector IX itself, In another implementation, the ranked list may he a reversal of the index vector IX. In yet another implementation, the ranked list may be the first k elements of the index vector.

FIG. 4 illustrates a flowchart showing an example of a method 400 for computing a blacklist of elements for the objects. Although execution of the method 400 is described below with reference to the system 10, the components for executing the method 400 may be spread among multiple devices/systems. The method 400 may be implemented in the form of executable instructions stored on a machine-readable storage medium, and/or in the form of electronic circuitry. In one example, the method 400 can be executed by at least one processor of a computing device (e.g., processor 102 of device 100).

Computing the blacklist of elements that cannot duster centers may be performed iteratively, In one example, the processor may begin with computing a first element to be added to the blacklist. Then, the process may iterate a number of times, where each iteration may add another element to the blacklist The number of iterations (i.e., the size of the blacklist) must be smaller than the size of the ranked elements list for each object.

The method 400 begins at 420, where the processor may select a top ranked element from the ranked list of elements for an object. For example, the processor may evaluate the ranked list of elements for each object to determine the element with the highest value on the list (i.e., the top ranked element). The processor may perform this for all existing objects and may, therefore, ultimately determine a list with top ranked elements from all objects. Then, the processor may iteratively determine, for the top ranked element, the count of objects that have the same top ranked element (at 430). In other words, the processor may determine how many objects from the plurality of objects are associated with the same top ranked element. The reasoning behind is that the element with the highest count is usually not a very good element to use for clustering, because the duster that corresponds to that element will include a large number of objects.

At 440, the processor may identify the top ranked element from the top ranked element for all objects) with the highest count of objects. In other words, considering all evaluated objects in blocks 420-430, the processor may determine which is the top ranked element having the highest count of objects.

Next, the processor may place the element with the highest count of objects on the blacklist of elements (at 450). In other words, the processor may identify one element per iteration, and that element is to be included in the blacklist of elements. The process 400 may iterate a number of times, where the number of iterations must be smaller than the size of the ranked list for each object. For example, the processor may determine if any more iterations are required to add additional element to the blacklist (at 460). If no more iterations are required, the processor may end the process 400. If additional iterations are required, the process may return to 420 in order to add a new add a new element to the blacklist. The number of iterations may be based on a threshold, may be predetermined, or adaptive/flexible. The process 400 may end when the identified number of iterations is completed and the size of blacklist reaches a specific level. The proposed technique removes the most common elements for the objects and helps to distribute the objects to other elements, making clusters evenly distributed and better representing similarities between objects.

In one example, the first time the processor implements the method 400, there may be only one element on the blacklist of elements. in the next iteration, the processor may add another element to the black list, using the techniques described above. Thus, the processor may iteratively update the blacklist of elements by including another element having the highest count of objects from the top ranked elements for the plurality of objects. When another element is being added, the processor may exclude elements that are already on the blacklist of elements from the top ranked list of elements. In other words, while updating the blacklist, the processor may not consider elements that are already on the list

In addition, during the implementation of the method 400 the processor may identify a plurality of elements having the highest count of objects from the elements for the plurality of objects. In other words, the processor may simultaneously identify several elements to be included on the blacklist. Then, the processor may place the plurality of elements having the highest count of objects on the blacklist of elements. Thus, the processor may update the blacklist by adding multiple elements at once. The number of multiple elements added to the blacklist may be predetermined or flexible. After the blacklist of elements is updated, the processor may reassign an object to a different duster center. Thus, is some examples, the objects may be reevaluated and added to a different duster based on the updated blacklist.

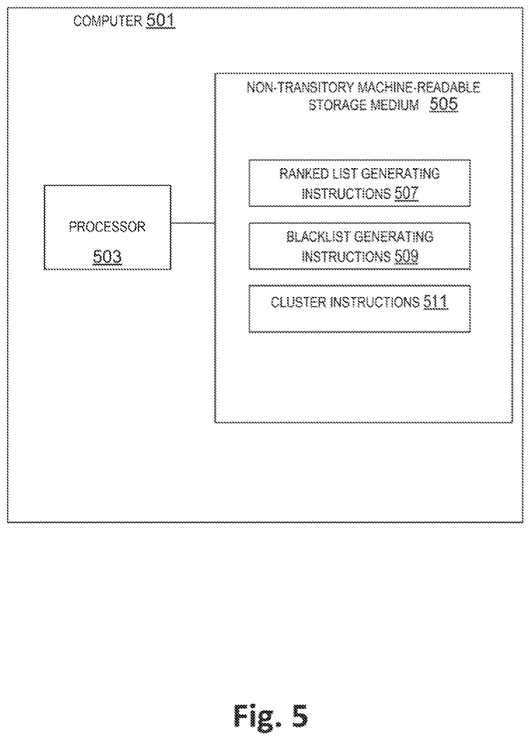

FIG. 5 illustrates a computer 501 and a non-transitory machine-readable storage medium 505 according to an example. In one example, the computer 501 maybe similar to the computing device 100 of the system 10 or may include a plurality of computers. For example, the computer may be a server computer, a workstation computer, a desktop computer, a laptop, a mobile device, or the like, and may be part of a distributed system. The computer may include one or more processors and one or more machine-readable storage media. In one example, the computer may include a user interface (e.g., touch interface, mouse, keyboard, or gesture input device).

Computer 501 may perform methods 200-400 and variations thereof, Additionally, the functionality implemented by computer 501 may be part of a larger software platform, system, application, or the like. Computer 501 may be connected to a database (not shown) via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

The computer 501 may include a processor 503 and non-transitory machine-readable storage medium 505. The processor 503 (e.g., a central processing unit, a group of distributed processors, a microprocessor, a microcontroller, an application-specific integrated circuit (ASIC), a graphics processor, a multiprocessor, a virtual processor, a cloud processing system, or another suitable controller or programmable device) and the storage medium 505 may be operatively coupled to a bus. Processor 503 can include single or multiple cores on a chip, multiple cores across multiple chips, multiple cores across multiple devices, or combinations thereof.

The storage medium 505 may include any suitable type, number, and configuration of volatile or non- volatile machine-readable storage media to store instructions and data. Examples of machine-readable storage media include read-only memory (“ROM”), random access memory (“RAM”) (e.g., dynamic RAM [“DRAM”], synchronous DRAM [“SDRAM”]), electrically erasable programmable read-only memory (“EEPROM”), magnetoresistive random access memory (MRAM), memristor, flash memory, SD card, floppy disk, compact disc read only memory (CD-ROM), digital video disc read only memory (DVD-ROM), and other suitable magnetic, optical, physical, or electronic memory on which software may be stored.

Software stored on the non-transitory machine-readable storage medium 505 and executed by the processor 503 includes, for example, firmware, applications, program data, filters, rules, program modules, and other executable instructions. The processor 503 retrieves from the machine-readable storage medium 505 and executes, among other things, instructions related to the control processes and methods described herein.

The processor 503 may fetch, decode, and execute instructions 507-511 among others, to implement various processing. As an alternative or in addition to retrieving and executing instructions, processor 503 may include at least one integrated circuit (IC), other control logic, other electronic circuits, or combinations thereof that include a number of electronic components for performing the functionality of instructions 507-511. Accordingly, processor 503 may be implemented across multiple processing units and instructions 507-511 may be implemented by different processing units in different areas of computer 501.

The instructions 507-511 when executed by processor 503 (e.g., via one processing element or multiple processing elements of the processor) can cause processor 503 to perform processes, for example, methods 200-400, and/or variations and portions thereof. In other examples, the execution of these and other methods may be distributed between the processor 503 and other processors in communication with the processor 503.

For example, ranked list generating instructions 507 may cause processor 503 to compute a ranked elements list for each of a plurality of objects. These instructions may function similarly to the techniques described in block 210 of method 200 and the techniques described in method 300. In one example, the ranked list generating instructions 507 may cause processor 503 to: compute a replicated vector for each object from an input vector associated with the object; apply a random permutation to the replicated vector for each object; perform an orthogonal transform to the replicated vector for each object to generate an index vector; and generate a ranked elements list for each object from the index vector.

Blacklist generating instructions 509 may cause the processor 503 to iteratively compute a blacklist of elements for the objects and to iteratively update the blacklist of elements by including at least one new element having highest count of objects. These instructions may function similarly to the techniques described in block 220 of method 200 and the techniques described in relation to the method 400. For example, blacklist generating instructions 509 may cause the processor 503 to select a top ranked element from the ranked list of element; iteratively determine, for the top ranked element, the count of objects that have the same top ranked element; identify the top ranked element with a highest count of objects; and place the element with the highest count of objects on the blacklist of elements. Further, the blacklist generating instructions 509 may cause the processor 503 to reassign an object to a different cluster center after updating the blacklist of elements.

Cluster instructions may cause the processor to determine cluster centers that include top ranked non-blacklisted elements, and to assign each object to at least one cluster center. These instructions may function similarly to the techniques described blocks 230-240 of method 200.

In the foregoing description, numerous details are set forth to provide an understanding of the subject matter disclosed herein. However, implementations may be practiced without some or all of these details. Other Implementations may include modifications and variations from the details discussed above. It is intended that the appended claims cover such modifications and variations.

What is claimed is:

1. A method comprising:
computing, via a processor, a d elements list for each of a plurality of objects;
iteratively computing, via the processor, a blacklist of elements for the objects;
determining, via the processor, cluster centers that include top ranked non-blacklisted elements; and
assigning, via the processor, each object to at least one cluster center.

2. The method of claim 1, wherein computing a raked elements list comprises:
computing, via the processor, a replicated vector for each object from an input vector associated with the object;
applying, via the processor, a random permutation to the replicated vector for each object;
performing, via the processor, an orthogonal transform to the replicated vector for each object to generate an index vector; and
generating, via the processor, a ranked elements list for each object from the index vector.

3. The method of claim 1, wherein computing the blacklist of elements comprises:
iteratively performing:
selecting, via the processor, a to ranked element from the ranked list of elements for an object,
iteratively determining, via the processor, for the top ranked element, the count of objects that have the same top ranked element,
identifying, via the processor, the top ranked element with a highest count of objects, and
placing, via the processor, the element with the highest count of objects on the blacklist of elements.

4. The method of claim 3, further comprising:
iteratively updating, via the processor, the blacklist of elements by including another element having the highest count of objects from the top ranked elements for the plurality of objects, wherein the ranked list of elements excludes elements that are already on the blacklist of elements.

5. The method of claim 3, further comprising:
identifying, via the processor, a plurality of elements having the highest count of objects from the elements for the plurality of objects;
placing, via the processor, the plurality of elements having the highest count of objects on the blacklist of elements,

6. The method of claim 1, wherein the ranked elements list includes an index of elements of each of the objects.

7. A system comprising;
a ranked list generating engine to compute a ranked elements list for each of a plurality of objects, wherein the ranked elements list is computed by using an orthogonal transform;
a blacklist engine to iteratively compute a blacklist of elements for the objects; and
a clustering engine to:
determine cluster centers that include top ranked non-blacklisted elements, and
assign each object from to t least one cluster cuter.

8. The system of claim 7, wherein the ranked list g negating engine is further to:
compute a replicated vector for each object from an input vector associated with the object;
apply a random permutation to the replicated vector for each object;
perform orthogonal transform to the replicated vector for each object to generate an index vector; and
generate a ranked elements list for each object from the index vector.

9. The system of claim 7, wherein the blacklist engine is further to:
iteratively perform:
select a top ranked element from the ranked elements list for an object,
iteratively determine, for the too ranked element, the count of objects that have the same top ranked element,
identify the top ranked element with a highest count of objects, and
place the element with the highest count of objects on the blacklist of elements.

10. The system of claim 7, wherein the blacklist engine is further to:
iteratively update the blacklist of elements by including another element having the highest count of objects from the top ranked elements for the plurality of objects, wherein the ranked list of elements excludes elements that are already on the blacklist of elements.

11. The system of claim 7, wherein the blacklist engine is further to:
identify a plurality of elements having the highest count of objects from the elements for the plurality of objects; and
place the plurality of elements having the highest count of objects on the blacklist of elements.

12. A non-transitory machine-readable storage medium encoded with instructions executable by at least one processor, the machine-readable storage medium comprising instructions to:
compute a ranked elements list for each of a plurality of objects;
iteratively compute a blacklist of elements for the objects;
iteratively update the blacklist of elements by including at least one new element having highest count of objects;
determine cluster centers that include top ranked non-blacklisted elements; and
assign each object to at least Anne cluster center.

13. The non-transitory machine-readable storage medium of claim 12, further comprising instructions to: reassign an object to a different cluster center after updating the blacklist of elements.

14. The non-transitory machine-readable storage medium of claim 12, further comprising instructions to:
compute a replicated vector for each object from an input vector a associated with the object;
apply a random permutation to the replicated vector for each object;
perform an orthogonal transform to the replicated vector for each object to generate an index vector; and
generate a ranked list for each object from the index vector.

15. The non-transitory machine-readable storage medium of claim 12, further comprising instructions to:
iteratively perform:
select a top ranked element from the ranked list of elements or an object,
iteratively determine, for the top ranked element, the count of objects that have the same top ranked element,
identify the top ranked element with a highest count of objects, and
place the element with the highest count of objects on the blacklist of elements.
